(19) United States
(12) Patent Application Publication
(10) Pub. No.: US 2009/0015568 A1
(43) Pub. Date: Jan. 15, 2009

(54) Method and Apparatus for Implementing Slider Detents

(76) Inventor: David A. Koski, San Jose, CA (US)

Correspondence Address: TECHNOLOGY & INNOVATION LAW GROUP, PC, ATTN: 101, 19200 STEVENS CREEK BLVD., SUITE 240, CUPERTINO, CA, 95014, US

(21) Appl. No.: 11/777,004

(22) Filed: Jul. 12, 2007

(51) Int. Cl. G06F 3/033

(52) U.S. Cl. 345/184

(57) ABSTRACT

Improved techniques that enable slider detents to be implemented are disclosed. According to one aspect, a method includes determining when a user interface control displayed on a display screen has been selected. The user interface control is moved at a speed that is imparted by a pointing device. The method also includes displaying a position indication on the display screen that represents current positions of the pointing device and the user interface control, and determining whether the current position is in a zone of slowed movement. A first set of information is provided to the pointing device when the current position is in the zone of slowed movement. The first set of information reduces the speed. A second set of information is provided to the pointing device when the current position is not in the zone of slowed movement. The second set of information maintains the speed.

### CROSS-REFERENCE TO RELATED APPLICATIONS

This application is related to (i) U.S. application Ser. No. ______ [Att. Dkt. No.: 101-P581/P5125US1], filed concurrently, and entitled “RESPONSIVENESS CONTROL SYSTEM FOR POINTING DEVICE MOVEMENT WITH RESPECT TO A GRAPHICAL USER INTERFACE,” which is hereby incorporated herein by reference; and (ii) U.S. application Ser. No. ______ [Att. Dkt. No.: 101-P580/P5124US1], filed concurrently, and entitled “RESPONSIVENESS CONTROL METHOD FOR POINTING DEVICE MOVEMENT WITH RESPECT TO A GRAPHICAL USER INTERFACE,” which is hereby incorporated herein by reference.

### BACKGROUND OF THE INVENTION

1. Field of the Invention

The present invention relates to graphical user interfaces and, more particularly, to the control of scrolling through contents presented in an application window.

2. Description of the Related Art

In recent years, display screens (e.g., monitors) used by personal computers have generally gotten larger in size and in pixel density. These display screens are used to present graphical user interfaces. The graphical user interfaces support various user interface controls to facilitate user interaction with the graphical user interfaces. Typically, user interface controls such as sliders are selected using a mouse or other pointing device. Using the mouse or other pointing device, a user maneuvers a cursor over a slider displayed as part of an application window, then activates the slider by clicking a button associated with the mouse or other pointing device.

In many applications, functionality is provided to allow scrolling through contents of an application window. When scrolling through contents of a window, some applications display an indicator in the window which provides an indication of what is being passed during the scrolling. By way of example, when scrolling through a multipage document displayed in an application window, as the boundary between two pages is scrolled past, an indication of the page that has just been passed or traversed during scrolling may be displayed. Alternatively, the page that is currently being scrolled through may be displayed.

However, when a user who is scrolling through a document sees an indication of the page that he or she would like to stop scrolling at, it is often difficult for the user to actually stop at his or her desired page. Often, by the time an indication of a desired page is displayed and the user responds by taking appropriate steps, e.g., releasing a mouse pointer so that a slider used to facilitate scrolling is substantially disengaged to stop a scrolling process, the desired page has been passed. The user then has to page down or up the document to relocate the desired page, which may be both time-consuming and frustrating to the user.

Therefore, what is needed is a method and an apparatus which allows a scrolling process to be efficiently controlled. That is, what is desired is a method and an apparatus which provides a user with an increased likelihood of stopping a scrolling process at a desired point of interest.

### SUMMARY OF THE INVENTION

The present invention pertains to techniques that enable control of responsiveness to user movement of a pointing device with respect to a graphical user interface. By controlling responsiveness, the invention may effectively impose a friction effect to provide a zone of automatically slowed movement with respect to a slider arrangement.

The present invention may be implemented in numerous ways, including, but not limited to, as a method, system, device, apparatus (including graphical user interface), or computer readable medium. Several embodiments of the present invention are discussed below.

According to one aspect of the present invention, a method for operating a pointing device with respect to display screen of a computing device includes determining when a user interface control displayed on the display screen has been selected using the pointing device. The user interface control is moved at a first speed that is imparted by the pointing device. The method also includes displaying a position indication on the display screen that represents a current position of the pointing device and a current position of the user interface control, and determining whether the current position is in a first zone of slowed movement. A first set of information is provided to the pointing device when the current position is in the first zone of slowed movement. The first set of information reduces the first speed. A second set of information is provided to the pointing device when the current position is not in the first zone of slowed movement. The second set of information maintains the first speed.

According to another aspect of the present invention, a computing system includes a display screen for presenting a graphical user interface that has a slider arrangement, the slider arrangement including a slider and a bar, the bar including at least a first zone of slowed movement. The computing system also includes a pointing device and a movement control system. The pointing device is used by a user to provide user input so as to manipulate a position indicator being displayed on the display screen, and allows the user to engage the slider and to manipulate the slider relative to the bar. The movement control system is configured to receive the user input via the pointing device, determine whether the slider is at least partially positioned in the zone of slowed movement, and automatically slow movement of the slider when the slider is at least partially positioned in the zone of slowed movement.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like structural elements, and in which:

FIG. 1A is a diagrammatic representation of an application window with a slider arrangement in which a slider is in a zone of automatically slowed movement in accordance with an embodiment of the present invention.

FIG. 1B is a diagrammatic representation of an application window with a slider arrangement, i.e., application window 100 of FIG. 1A, in which a slider is in a zone of regular or unslowed movement in accordance with an embodiment of the present invention.

FIG. 2 is a diagrammatic representation of a slider bar that includes zones of automatically slowed movement for an application that includes a document or a file that is divided into pages in accordance with an embodiment of the present invention.

FIG. 3 is a diagrammatic representation of a slider bar that includes zones of automatically slowed movement for an application that includes a collection that is divided alphabetically in accordance with an embodiment of the present invention.

FIG. 4A is a diagrammatic representation of a zone of automatically slowed movement that substantially surrounds a point of interest in accordance with an embodiment of the present invention.

FIG. 4B is a diagrammatic representation of a zone of automatically slowed movement, i.e., zone 408 of FIG. 4A, in which a slider is at least partially present in accordance with an embodiment of the present invention.

FIG. 5 is a process flow diagram which illustrates a method of supporting slider detents associated with scrolling through a scrollable document, file, or collection in accordance with an embodiment of the present invention.

FIG. 6 is a block diagram representation of a system that supports slider detents or zones of automatically slowed movement in accordance with an embodiment of the present invention.

FIG. 7 is a process flow diagram which illustrates a method of creating zones of automatically slowed movement in accordance with an embodiment of the present invention.

FIG. 8 is a diagrammatic representation of a non-linear slider arrangement that includes zones of automatically slowed movement in accordance with an embodiment of the present invention.

FIG. 9 is a process flow diagram of a responsiveness control process in accordance with an embodiment of the present invention.

FIG. 10 is a process flow diagram of a mouse pointer movement process in accordance with an embodiment of the invention.

### DETAILED DESCRIPTION OF THE INVENTION

The invention pertains to techniques that enable control of responsiveness to user movement of a pointing device with respect to a graphical user interface. By controlling responsiveness, the invention can impose a friction effect at predetermined regions of the graphical user interface, particularly those associated with scroll bars displayed in an application window. The responsiveness control, or frictional effect, may be used to enhance user interaction with the graphical user interface.

Providing feedback functionality or a feedback mechanism that allows user interface controls such as sliders to effectively “stick” near points of interest associated with contents displayed in an application window increases the likelihood that users of the sliders will be able to stop a scrolling process right at the points of interest if desired. In one embodiment, the movement of a slider or similar element that is used to scroll through a document is substantially automatically slowed near points of interest. By automatically slowing the movement of a slider near points of interest, e.g., by a predetermined scaling factor, a user who is scrolling through contents displayed in an application window may be more aware that a point of interest is nearby, and may be more likely to stop scrolling at the point of interest he or she desires.

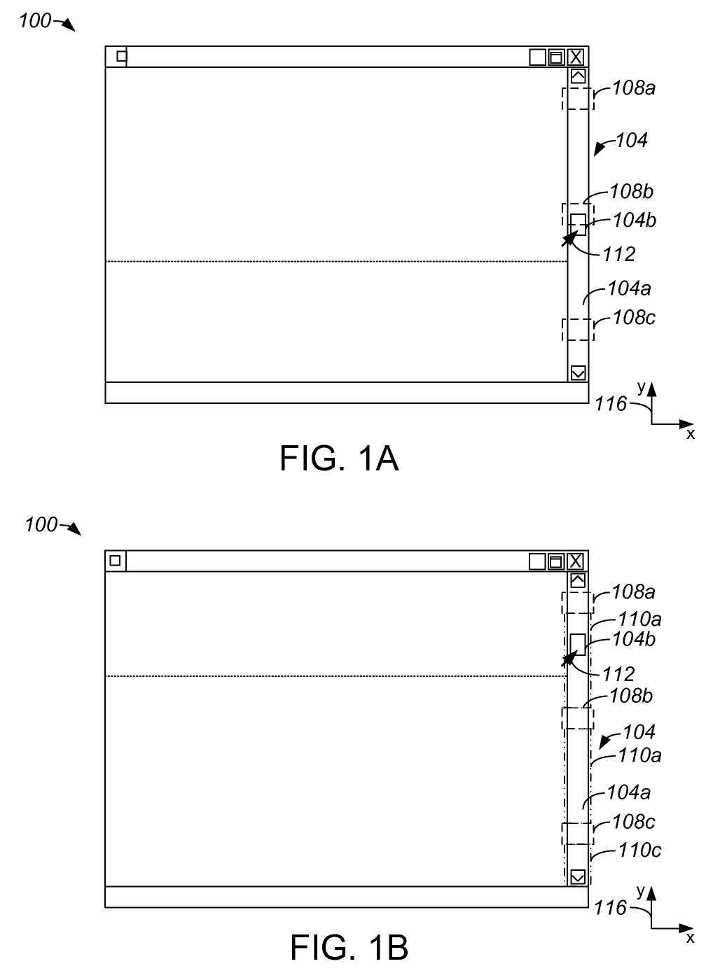

Embodiments of the invention are discussed below with reference to FIGS. 1A-10. However, those skilled in the art will readily appreciate that the detailed description given herein with respect to these figures is for explanatory purposes as the invention extends beyond these limited embodiments.

Referring initially to FIG. 1A, a slider arrangement in which a slider is in a zone of automatically slowed movement will be described in accordance with an embodiment of the present invention. An application window 100, which may be displayed on a monitor or similar device associated with a computing system, is arranged to enable contents (not shown) displayed or otherwise presented in application window 100 to be viewed through scrolling, e.g., text crawling. As will be appreciated by those skilled in the art, scrolling provides a way to display relatively large amounts of content which may not be displayed at substantially the same time in application window 100.

Application window 100 includes a slider arrangement or scrollbar arrangement 104. Slider arrangement 104 includes a bar 104a and a slider 104b. Slider 104b is arranged to slide over bar 104a, as for example when a person or entity that controls a cursor 112 effectively engages slider 104b to move slider 104b. Control of cursor 112, which is a position indicator or a marker that is essentially a manifestation of the movement of a mouse pointer in one embodiment, may be achieved by engaging the mouse pointer, and moving the mouse pointer to move cursor 112. When a user causes movement of the mouse pointer, the movement is recognized, and cursor 112 may be correspondingly moved. Typically, slider arrangement 104 is oriented in either a horizontal direction or a vertical direction. In the described embodiment, slider arrangement 104 is oriented in a vertical direction, i.e., along a y-axis 116.

Slider arrangement 104 is associated with zones or regions 108a-c of automatically slowed movement, or slower movement zones. Typically, zones 108a-c are defined around points of interest or slider detents (not shown). When slider 104b and/or cursor 112 is at least partially present in one of zones 108a-c, the speed at which cursor 112 effectively moves slider 104b is automatically slowed. It should be appreciated that cursor 112 or, more generally, a position indicator associated with a user interface device, is at least partially displayed on slider 104b and is also an indication of the position of slider 104b.

As shown, slider 104b is partially in zone 108b. Hence, the speed at which slider 104b is being moved, and the speed at which a user interface device that effectively moves slider 104b is being moved, along y-axis 116 is automatically slowed.

In one embodiment, when the speed at which a user may cause slider 104b to move is slowed, the speed may be slowed to a predetermined percentage of the speed at which the user is attempting to cause slider 104b to move. By way of example, if a user is attempting to move slider 104b at a speed of approximately “N” pixels per second, slider 104b may be slowed to a speed of approximately “0.5N” pixels per second within zone 108b. A scaling factor by which the speed at which slider 104b may move may be widely varied, and may be determined by any suitable method. For instance, a scaling factor may be associated with a step function, determined through experimentation, and/or determined at least partially based on factors such as the acceleration of a mouse pointer. Alternatively, the speed at which slider 104b moves in zone 108b may be slowed to a predetermined speed that is substantially independent of the speed at which the user is attempting to move slider 104b, e.g., the speed may be a substantially constant speed over which the user has substantially no control.

It should be appreciated that the control of the speed at which slider 104b moves when slider 104b has entered into a zone 108a-c may be implemented by an application associated with application window 100. The application may include, but is not limited to including, executable software code devices embodied in a tangible media and executing on a processor of a computing device, as well as logic associated with a graphics integrated circuit or system of the computing device.

When slider 104b is not within one of zones 108a-c, and cursor 112 is used to cause slider 104b to slide along bar 104a, the controller of cursor 112 effectively controls the speed at which slider 104b moves without any interference from an application. In other words, a user who is attempting to scroll through contents (not shown) presented on application display 100 may exercise control over the speed at which slider 104b moves without substantially forced slowing. Typically, when slider 104b is not within one of zones 108a-c, slider 104b is considered to be within a zone of regular or unslowed movement. FIG. 1B is a diagrammatic representation of application window 100 of FIG. 1A in which slider 104b is in a zone of regular or unslowed movement in accordance with an embodiment of the present invention. Zones 110a-c of unslowed movement are defined between zones 108a-c. For example, zone 110a of unslowed movement is defined between zone 108a and zone 108b, while zone 110b of unslowed movement is defined between zone 108b and zone 108c.

When cursor 112 is engaged on slider 104b, and slider 104b is located in one of zones 110a-c, then slider 104b is effectively free to move along bar 104a substantially without being slowed. When slider 104b is effectively free to move along bar 104a without being slowed, the speed at which slider 104b moves is effectively exclusively controlled by a user. Hence, a user may exercise substantially exclusive control over the speed at which scrolling through contents (not shown) displayed in application display 100 occurs.

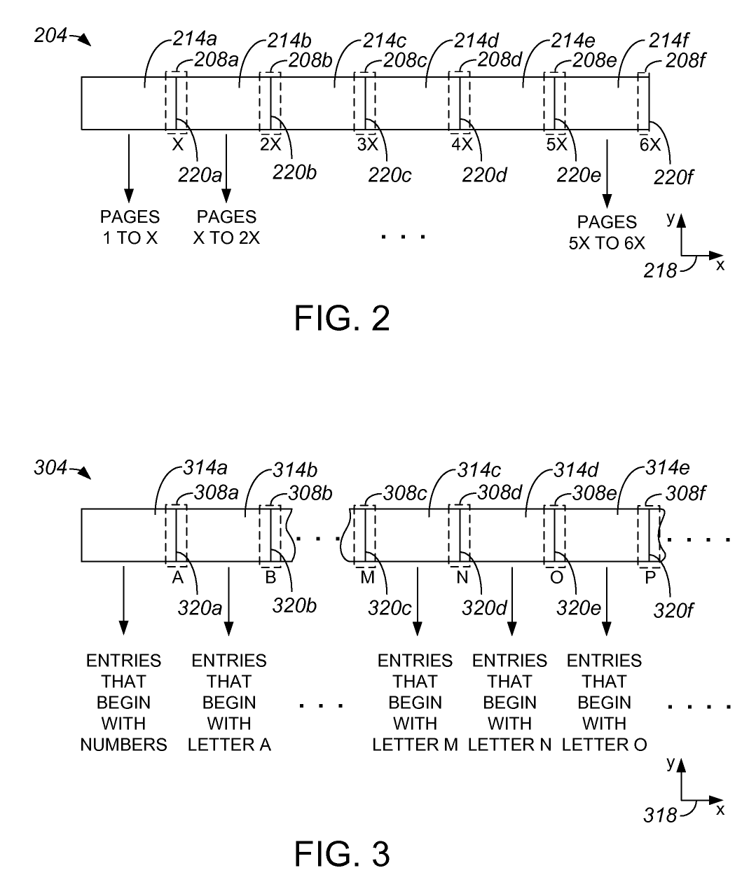

A slider arrangement may be arranged to allow scrolling through a variety of different types of content displayed in an application display. By way of example, a slider arrangement may be associated with a document or file that is divided into pages, or a slider arrangement may be associated with a collection that is arranged in alphabetical order. With reference to FIG. 2, a slider bar for a document or file that uses pages as points of interest or detents will be described, while with reference to FIG. 3, a slider bar for a collection that uses alphabetical markers as points of interest will be described.

FIG. 2 is a diagrammatic representation of a slider bar that includes zones of automatically slowed movement, for an application that includes a document or a file that is divided into pages in accordance with an embodiment of the present invention. A slider bar 204 is arranged such that a slider (not shown) may translate over slider bar 204 during a scrolling process relative to an x-axis 218. In the described embodiment, slider bar 204 is associated with a document or a file that includes multiple pages with every “X” number of pages being a predetermined point of interest or detent.

Each point of interest 220a-f has an associated zone 208a-f of automatically slowed movement, respectively. In one embodiment, zones 208a-f may be friction areas, as described in co-pending U.S. patent application Ser. No. ______ (Attorney Docket No. 101-P581/P5125US1), which is incorporated by reference. A friction area is a predetermined area associated with a graphical user interface that is designated to impose a frictional effect to mouse movement when within the friction area.

The size of zones 208a-f may vary depending upon the requirements of a particular application, or upon the preferences of a user. Although zones 208a-e have been shown as being of substantially the same size, with zone 208f being approximately have the size of each of zones 208a-e because point of interest 220f is the last page associated with slider bar 204, it should be appreciated that each zone 208a-f may have a different size.

Zones 214a-f of regular movement are located on slider bar 204, generally between consecutive zones 208a-f of automatically slowed movement. By way of example, zone 214c of regular movement is positioned between zone 208b of automatically slowed movement and zone 208c of automatically slowed movement. Zone 208a may include a portion of page “X+1” and a portion of page “X−1” or, in some embodiments, complete pages that are in the vicinity of page “X”.

When a slider (not shown) is moving at least partially in any one of zones 208a-f of automatically slowed movement, the speed at which a user is attempting to move the slider is automatically slowed such that the user is unable to move the slider as quickly as he or she attempting to move the slider. When a slider (not shown) is not moving at least partially in one of zones 208a-f of automatically slowed movement, and is substantially completely in one of zones 214a-f of regular movement, a user exercises substantially complete control over the speed at which the slider moves. That is, if a slider (not shown) is moving substantially only in a zone 214a-f of regular or unslowed movement, the speed at which a user is attempting to move the slider is generally approximately the speed at which the slider moves.

FIG. 3 is a diagrammatic representation of a slider bar that includes zones of automatically slowed movement for an application that includes a collection that is divided alphabetically in accordance with an embodiment of the present invention. A slider bar 304 is arranged such that a slider (not shown) may translate over slider bar 304 during a scrolling process relative to an x-axis 318. As shown, slider bar 304 is associated with a collection, as for example a collection of music or a collection of files, that is catalogued in alphabetical order. Each letter of the alphabet is a point of interest or a detent 320a-f that has an associated zone 308a-f of automatically slowed movement, respectively.

Zones 314b-f of regular movement are positioned substantially between consecutive zones 308a-f of automatically slowed movement, while zone 314a is positioned adjacent to zone 308a. When a slider (not shown) is moving at least partially in any one of zones 308a-f of automatically slowed movement, the speed at which a user is attempting to move the slider is automatically slowed such that the user is unable to move the slider as quickly as he or she attempting to move the slider. When a slider (not shown) is not moving at least partially in one of zones 308a-f of automatically slowed movement, and is substantially completely in one of zones 314a-f of regular movement, a user exercises substantially complete control over the speed at which the slider moves.

In the described embodiment, when a slider (not shown) enters a zone 308a-f, a scrolling process is near an associated point of interest 320a. For example, if a slider (not shown) enters zone 308a, the scrolling process is near the beginning of the elements in a collection that start with the letter “A.” An entry such as “Aardvark” is likely to be associated with zone 308a, while an entry such as “Apple” is more likely to be in zone 314b and an entry such as “Azalea” is more likely to be in zone 308b, i.e., the zone that substantially surrounds point of interest 320b.

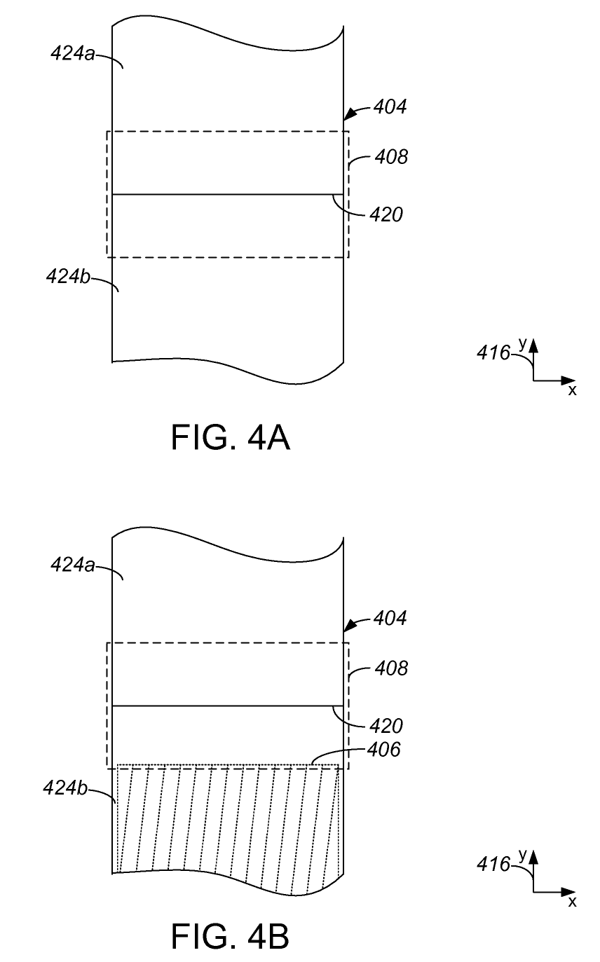

As previously mentioned, if a slider or similar element which is used in scrolling process is located at least partially within a zone of automatically slowed movement, the speed at which the slider is moved is automatically slowed, e.g., by a predetermined scaling factor. With reference to FIGS. 4A and 4B, zones of automatically slowed movement will be described in accordance with an embodiment of the present invention. FIG. 4A is a diagrammatic representation of a zone of automatically slowed movement that substantially surrounds a point of interest in accordance with an embodiment of the present invention, and FIG. 4B is a diagrammatic representation of the zone of automatically slowed movement of FIG. 4A in which a slider is at least partially located in accordance with an embodiment of the present invention. A portion of a slider arrangement 404, as for example a slider bar, includes a point of interest or detent 420. Point of interest 420 is substantially any interesting value associated with contents presented in an application window. Surrounding point of interest 420 is a zone 408 of automatically slowed movement. Adjacent to zone 408 of automatically slowed movement are zones 424a, 424b of regular movement.

When a slider 406 moves in a y-direction 416 and enters zone 408 of automatically slowed movement, the speed at which slider 406 moves automatically slows. A user who is moving slider, e.g., by dragging slider 406, may experience sticking or resistance when moving slider. That is, the user will typically be unable to move the slider at his or her desired speed because the movement of the slider in y-direction 416 is automatically slowed. As will be appreciated by those skilled in the art, dragging slider 406 may include “clicking” on slider 406 with a mouse pointer and moving the mouse pointer while slider 406 effectively remains selected. Once slider 406 is no longer in zone 408 of automatically slowed movement, and is in one of zones 424a, 424b of regular movement, the user will generally be able to move the slider at his or her desired speed.

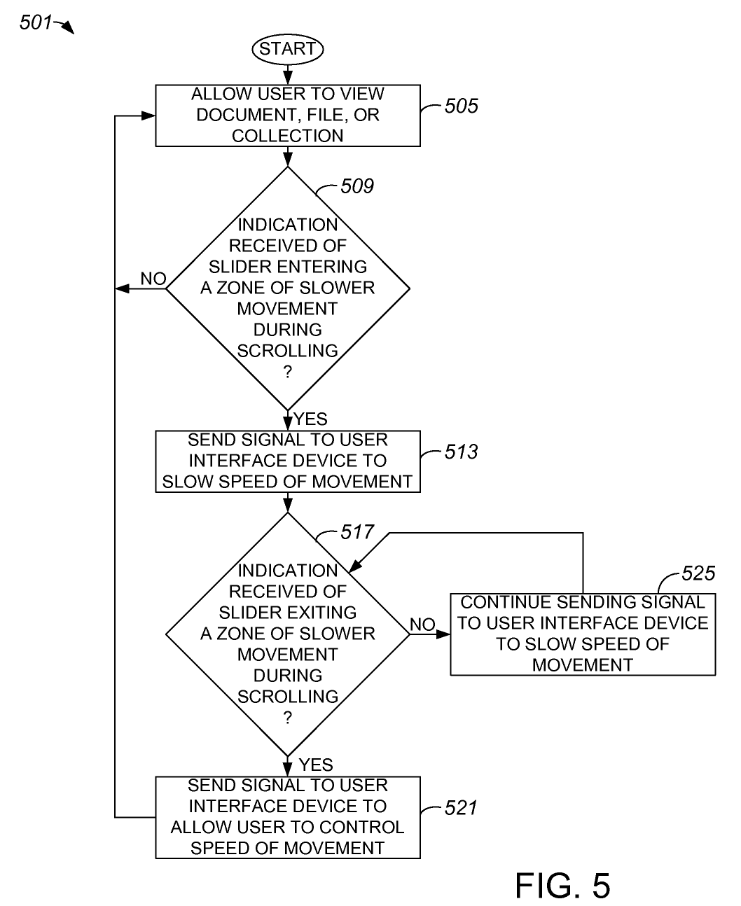

FIG. 5 is a process flow diagram which illustrates a method of supporting slider detents associated with scrolling through a scrollable document, file, or collection in accordance with an embodiment of the present invention. A process 501 of operating an application that supports slider detents or scrolling through zones of regular speed and zones of automatically slowed movement begins at step 505 in which a user is allowed to view a document, file, or collection presented by the application. Typically, the application includes a graphical user interface or scrollable window in which the document, file, or collection, i.e., contents, are displayed or otherwise presented.

After a user views contents in an application window, it is determined in step 509 whether an indication that a slider has entered a zone of automatically slowed movement is received, i.e., by the application that supports slider detents. In general, the application is arranged to differentiate between a cursor entering a zone of automatically slowed movement without being associated with a slider, and a cursor-controlled slider entering the zone of automatically slowed movement during scrolling. If it is determined that no indication is received of a slider entering a zone of automatically slowed movement, then process flow returns to step 505 in which the user continues to view contents in an application window.

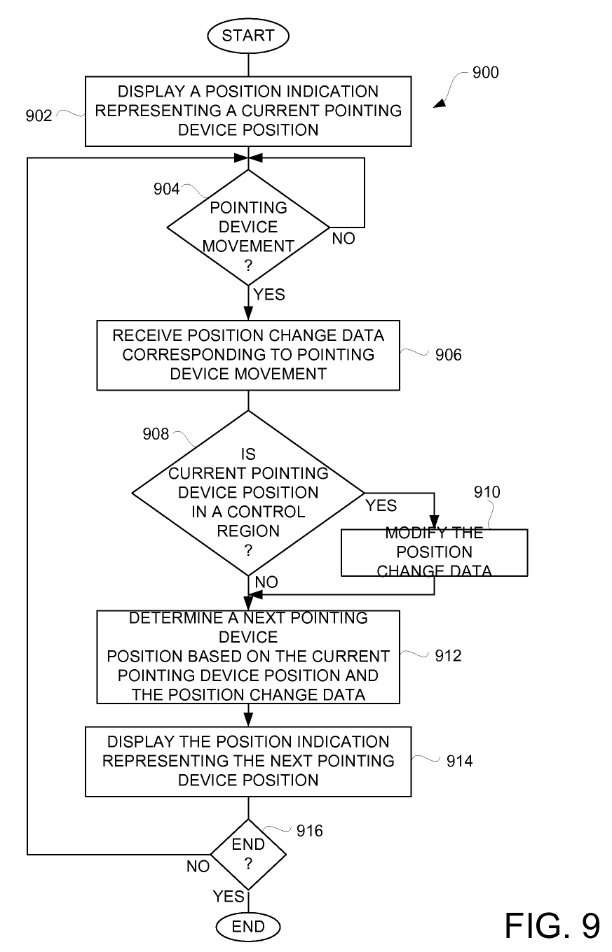

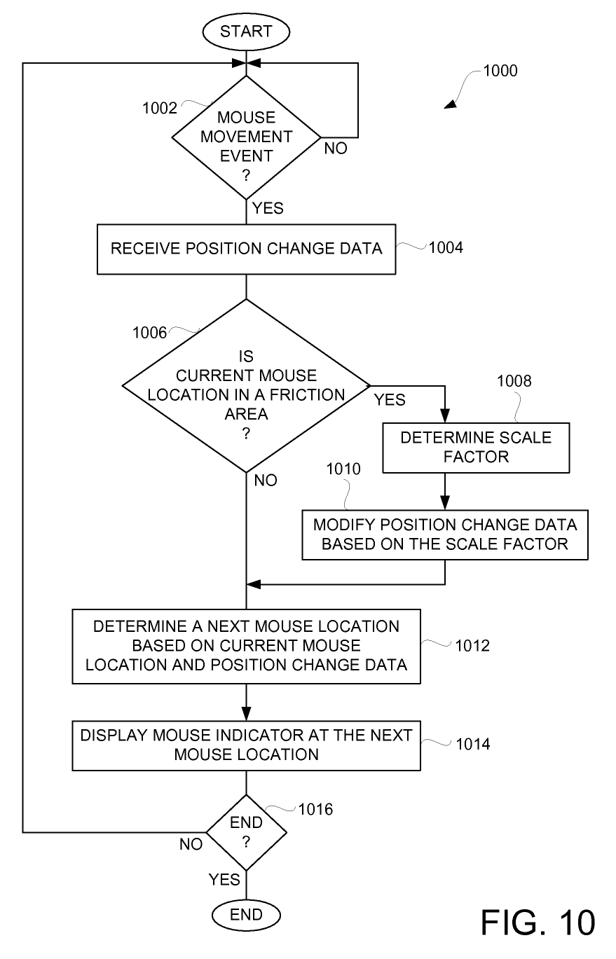

Alternatively, if it is determined in step 509 that an indication has been received of a slider entering a zone of automatically slowed movement, then a signal is sent to a user interface device that is used to move the slider in step 513. That is, the movement of the slider is automatically slowed once the slider is determined to have entered a zone of automatically slowed movement. The movement of the slider remains automatically slowed as long as a portion of the slider remains in the zone of automatically slowed movement. One responsiveness control process that may be used to control the movement of the slider will be described below with respect to FIG. 9, and one process of controlling the movement of a mouse pointer will be described below with reference to FIG. 10.

From step 513, process flow moves to step 517 in which it is determined if the slider has exited a zone of automatically slowed movement. In other words, it is determined when a current position indication is received which indicates that substantially no portion of the slider remains within a zone of automatically slowed movement. If it is determined that the slider has not exited a zone of automatically slowed movement, then in step 525, the slider remains automatically slowed. That is, the user interface device that is used to move the slider continues to receive a signal to continue an automatically slowed speed of movement. A current position associated with the user interface device may indicate that the slider is still within a zone of automatically slowed movement. From step 525, process flow returns to step 517 and a determination of whether the slider has exited a zone of automatically slowed movement.

If the determination in step 517 is that the slider has exited a zone of automatically slowed movement, the implication is that the slider has entered a zone of regular movement. As such, in step 521, the application sends a signal, e.g., to the user interface device that is used to move the slider, which indicates that the movement of the slider is no longer to be automatically slowed. When the movement of the slider is no longer automatically slowed, a user effectively has control of the speed at which the slider is to be moved. After the signal is sent to the user interface device to cease automatically slowing the movement of the slider, process flow returns to step 505 in which the user continues to view a document, file, or collection.

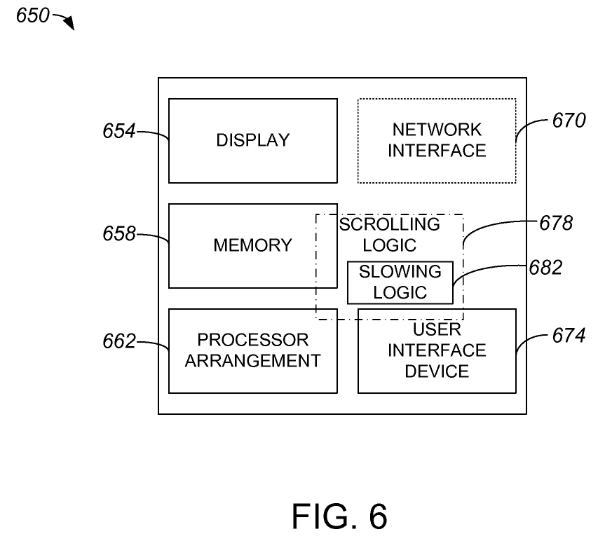

An application that supports slider detents may generally be executed on any suitable computing system. FIG. 6 is a block diagram representation of an example system that supports slider detents or zones of automatically slowed movement in accordance with an embodiment of the present invention. A computing system 650 includes a display 654, a memory 658, a processor arrangement 662, and an optional network interface 670. System 650 also includes scrolling logic 678 that is configured or otherwise arranged to implement a slider arrangement or a scroll bar within an application window (not shown) displayed on display 654. Scrolling logic 678, which may include hardware logic and/or software code devices embodied in a tangible medium, includes slowing logic 682, or logic that implements zones of automatically slowed movement with respect to slider arrangements. In one embodiment, scrolling logic 678 is at least partially stored on memory 658, and may be executed by processor arrangement 662. Further, scrolling logic 678 may be arranged to cause a user interface device 674 to be associated with a slowed speed of movement when user interface device 674 is used to move a slider into a zone of automatically slowed movement within a slider arrangement. User interface device 674 may be, but is not limited to being, a mouse, touchpad, trackball, keyboard, stylus, pointer, or substantially any device which is associated with the movement of a cursor shown on display 654.

It should be appreciated that although computing system 650 may be a standalone computing system, computing system 650 may instead be a distributed computing system, e.g., a computing system in which an application that implements scrolling logic 678 may be hosted on a separate device from display 654 on which a slider arrangement is displayed. In other words, components of computing system 650 may be distributed across a network.

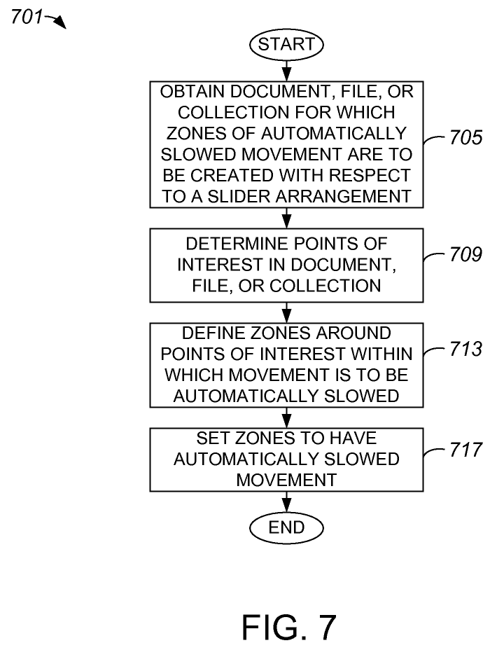

FIG. 7 is a process flow diagram which illustrates a method of creating zones of automatically slowed movement in accordance with an embodiment of the present invention. A process 701 of creating zones of automatically slowed movement begins at step 705 in which a document, file, or collection for which the zones are to be created is obtained. As previously mentioned, zones of automatically slowed movement are associated with a slider arrangement that includes a bar and a slider. The document, file, or collection may be obtained by an application that creates the zones, for example, when there is an update to an existing document, file, or collection. The application may also obtain newly created documents, files, or collections.

Once the document, file, or collection is obtained, points of interest in the document, file, or collection are determined or otherwise identified in step 709. Identifying points of interest may include, but is not limited to including, identifying interesting values or intervals within a document, file, or collection. Interesting values may be substantially predetermined, e.g., every 10 pages in a document may be a point of interest. Alternatively, interesting values may be substantially dynamically determined, e.g., each document may be partitioned or otherwise divided such that it includes ten points of interest. That is, interesting values may be such that the intervals between interesting values vary depending upon the size of the associated document, file, or collection.

After the points of interest are determined or otherwise identified in step 709, zones are defined around the points of interest in step 713. In one embodiment, zones may have predetermined sizes and may cover a predetermined range around appoint of interest. Alternatively, zones may have sizes that are dynamically determined. For example, zones may have sizes that are based upon the number of points of interest or on the size of a document, file, or collection. The zones are defined such that if a cursor associated with a display enters into the zones, the movement of the cursor is substantially automatically slowed. Hence, in step 717, the zones are set to have automatically slowed movement. Setting the zones to have automatically slowed movement may include setting appropriate parameters in an application associated with a document, file, or collection to indicate that if a cursor being used with respect to a slider arrangement to effectively move a slider causes the slider to enter into a zone of automatically slowed movement, the movement of the slider is to be automatically slowed. Once the zones are set, the process of creating zones of automatically slowed movement is completed.

While a slider arrangement with zones of automatically slowed movement has been described as being associated with linear movement, or movement in which a slider is controlled to translate in a linear manner, a slider arrangement may instead be associated with non-linear movement. In other words, slider detents and zones of automatically slowed movement may be associated with a slider or similar configuration that utilizes non-linear movement. By way of example, a slider arrangement may include a knob which is rotated or otherwise turned within a circular equivalent of a slider bar such that when a particular portion of a knob is within a zone of automatically slowed movement, the rotational movement of the knob is slowed.

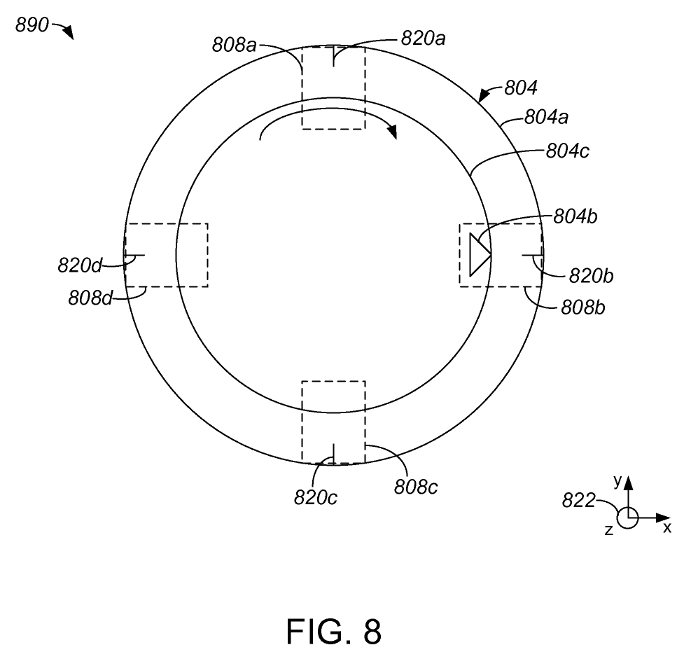

FIG. 8 is a diagrammatic representation of a slider arrangement that includes a knob with a portion that is arranged to substantially rotate through zones of automatically slowed movement in accordance with an embodiment of the present invention. A knob display 890 includes a slider arrangement 804. Knob display 890 may be a balance knob that has a zero detent. Slider arrangement 804 may include a base 804a and a rotational slider or mover 804c that includes a selection portion 804b and is arranged to rotate about a z-axis 822. Rotational slider 804c is arranged to rotate or turn with respect to base 804a such that selection portion 804b passes through zones of automatically slowed movement 808a-d defined around points of interest or detents 820a-d, respectively. In one embodiment, if knob display 890 is associated with a balance knob, point of interest 820a may be a zero detent.

When selection portion 804b is positioned within a zone of automatically slowed movement 808a-d, the speed at which rotational slider 804c rotates is automatically slowed. The amount by which the speed imparted on rotational slider 804c by a user, e.g., by manipulating a cursor (not shown) to engage selection portion 804b, is slowed may be scaled by a predetermined factor. The predetermined, or scaling factor, may generally be determined using any suitable method. In one embodiment, the scaling factor may be ascertained through experimentation. Alternatively, the rotation of rotational slider 804c may be automatically slowed to a predetermined speed regardless of the speed imparted by a user. As shown, selection portion 804b is within zone 804b, which is a zone of automatically slowed movement. Hence, the speed at which a user attempts to rotate or turn rotational slider 804c is automatically slowed.

Methods for controlling the responsiveness of a slider, e.g., controlling the responsiveness of a slider when the slider enters a zone of automatically slowed movement, and moving a mouse pointer that may be used to control the movement of a slider will be described with reference to FIG. 9 and FIG. 10, respectively. FIG. 9 is a process flow diagram of a responsiveness control process 900 according to an embodiment of the present invention. The responsive control process concerns control of the responsiveness of a pointing device with regard to user movement. More particularly, the responsiveness control process concerns the responsiveness of a visual position indication representing the position of the pointing device. Typically, the responsiveness control process 900 would be performed by a computing device having a display screen that presents a graphical user interface and permits a user to interact with the graphical user interface using the pointing device.

The responsiveness control process 900 may begin by display 902 of a position indication on the display screen. The position indication may be a cursor that represents a current pointing device position. A decision 904 may then determine whether there is pointing device movement. Here, a user may manipulate the pointing device to cause pointing device movement. For example, the pointing device may pertain to a mouse or a track ball. When the user causes movement of the mouse or the track ball, pointing device movement is recognized and the associated position indication being displayed can be correspondingly moved. When the decision 904 determines that there has not been pointing device movement, the responsiveness control process 900 may await pointing device movement.

Once the decision 904 determines that pointing device movement has been recognized, the responsiveness control process 900 may continue. In this regard, position change data corresponding to the pointing device movement may be received 906. In one embodiment, the position change data may be relative position change data based on the current pointing device position. As an example, the position change data may include a change in an X coordinate and a change in a Y coordinate. Next, a decision 908 determines whether the current pointing device position is in a control region. When the decision 908 determines that the current pointing device position is within a control region, the position change data may be modified 910. By modifying 910 the position change data, the responsiveness of the pointing device to user movement is able to be altered in the control region which, in one embodiment, is a zone of automatically slowed movement. Consequently, when the current pointing device position is within a control region, the behavior of the pointing device is able to be altered to assist the user in interacting with the graphical user interface with respect to the particular control region. For example, in a zone of automatically slowed movement, the movement of the pointing device is slowed such that the movement of a slider being controlled by the pointing device is effectively slowed.

Following the block 910 or directly following the decision 908 when the current pointing device position is not in a control region such as a zone of automatically slowed movement, a next pointing device position is determined in block 912 based on the current pointing device position and position change data. Since the position change data is typically relative to its current position, the position change data may often be added to the current pointing device position to determine the next pointing device position. The position indication representing the next pointing device position may then be displayed 914.

Thereafter, a decision 916 may determine whether the responsiveness control process 900 should end. When the decision 916 determines that the responsiveness control process 900 should not end, then the responsiveness control process 900 returns to repeat the decision 904 and subsequent blocks so that additional pointing device movement may be received and responded to in a similar manner. Alternatively, when the decision 916 determines that the responsiveness control process 900 should end, then the responsiveness control process 900 may end.

FIG. 10 is a process flow diagram of a mouse movement process 1000 according to one embodiment of the present invention. The mouse movement process 1000 concerns processing responsive to movement of a pointing device such as a mouse.

The mouse movement process 1000 may begin with a decision 1002 that determines whether a mouse movement event has occurred. In the described embodiment, the mouse movement event may be determined to have occurred when a slider that is controlled by the mouse is engaged and moved. When the decision 1002 determines that a mouse movement event has not occurred, the mouse movement process 1000 awaits such an event. Alternatively, when the decision 1002 determines that a mouse movement event has occurred, the mouse movement process 1000 may continue. In particular, position change data may be received 1004. The position change data may be relative to a current mouse rotation. In one embodiment, the position change data may reflect a change in position with respect to the current mouse location.

Next, a decision 1006 determines whether the current mouse location is within a zone of automatically slowed movement, e.g., a friction area. A friction area is a predetermined area associated with a graphical user interface that is designated to impose a frictional effect to mouse movement when within the friction area. In one embodiment, the mouse movement within the friction area is less responsive so that a user scrolling through windows using a slider on a scroll bar may more readily stop the scrolling process near a point of interest. When the decision 1006 determines that the current mouse location is within the friction area, a scale factor may be determined 1008. Next, position change data may be modified 1010, as for exampled automatically slowed, based on the scale factor.

Following the block 1010, or directly following the decision 1006 when the current mouse location is not within a friction area, a next mouse position is determined 1012 based on the current mouse location and the position change data. A mouse indicator may then be displayed 1014 at the next mouse location. In one embodiment, the next mouse location is displayed 1014 with reference to a graphical user interface.

Following the block 1014, a decision 1016 determines whether the mouse movement process 1000 should end. When the decision 1016 determines that the mouse movement process 1000 should not end, the mouse movement process 1000 returns to repeat the decision 1002 so that additional mouse movements are able to be similarly processed. On the other hand, when the decision 1016 determines that the mouse movement process 1000 should end, the mouse movement process 1000 ends.

Although only a few embodiments of the present invention have been described, it should be understood that the present invention may be embodied in many other specific forms without departing from the spirit or the scope of the present invention. By way of example, while the ability to automatically slow the movement of a slider near detents has been described, the automatic slowing of movement is not limited to an application associated with a slider. Zones of automatically slowed movement may be defined and implemented near points of interest associated with substantially any application that enables something to be selected and engaged.

Zones of automatically slowed movement may be defined in a variety of different applications. In one embodiment, a zone of automatically slowed movement may be defined with respect to applications which allow colors to be picked. For instance, if a color palette presented in an application display has points of interest or detents at particular colors, zones of automatically slowed movement may be defined around the particular colors such that the movement of a slider, cursor, or other element that is engaged and moved to allow colors to be selected may be automatically slowed within the zones.

The amount by which the movement of a slider is slowed in a zone of automatically slowed movement may vary. The amount of slowing may also vary within a single zone of automatically slowed movement. That is, in one embodiment, a scale factor associated with an amount by which movement is slowed in a zone of automatically slowed movement may be dependent upon the current cursor location within the zone of automatically slowed movement as compared to a center of the zone of automatically slowed movement. For example, the scale factor may be further reduced as the current cursor location gets closer to the center of a zone of automatically slowed movement.

Points of interest or detents may generally be selected to be substantially anything that is considered to be important within a document, file, or collection. In general, points of interest may be identified boundaries within a document, file, or collection. Points of interest may include, but are not limited to including, particular pages in a document, particular chapters in a document, particular integer values, particular dates, and particular alphabetical values. It should be appreciated that substantially anything within a document, file, or collection that is considered to be important may be a point of interest. Further, a point of interest may be identified substantially anywhere that is desired, e.g., desired by an application writer or a user, within a document, file, or collection.

In one embodiment, the movement of a slider may be automatically slowed in zones around points of interest or detents for a touch screen application without departing from the spirit or the scope of the present invention. For a touch screen application, a user may touch the slider on a display using a stylus or a finger, and effectively move the slider by maintaining contact between the stylus or the finger and the slider on the display while moving the stylus or the finger. If the touch screen application senses that the slider and/or the stylus has entered into a zone of automatic movement, the movement of the slider is slowed.

The invention is preferably implemented by software, hardware, or a combination of hardware and software. The invention may also be embodied as computer readable code or logic on a computer readable medium. The computer readable medium is typically any data storage device that may store data which may thereafter be read by a computer system. Examples of the computer readable medium include, but are not limited to including, read-only memory, random-access memory, CD-ROMs, DVDs, magnetic tape, optical data storage devices, and carrier waves. The computer readable medium may also be distributed over network-coupled computer systems so that the computer readable code is stored and executed in a distributed fashion.

The steps associated with the methods of the present invention may vary widely. Steps may be added, removed, altered, combined, and reordered without departing from the spirit of the scope of the present invention.

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A method for operating a pointing device with respect to display screen of a computing device, the method comprising:
determining when a user interface control displayed on the display screen has been selected using the pointing device;
moving the user interface control at a first speed, the first speed being imparted by the pointing device;
displaying a position indication on the display screen, the position indication being arranged to represent a current position of the pointing device and a current position of the user interface control;
determining whether the current position is in a first zone of slowed movement;
providing a first set of information to the pointing device when the current position is in the first zone of slowed movement, the first set of information being arranged to reduce the first speed; and
providing a second set of information to the pointing device when the current position is not in the first zone of slowed movement, the second set of information being arranged not to reduce the first speed.

2. The method of claim 1 wherein the user interface control is a slider associated with a slider arrangement, the slider arrangement including a bar over which the slider moves, and wherein the first zone of slowed movement is a first region associated with the bar.

3. The method of claim 2 wherein the bar includes a point of interest, and the first region is defined around the point of interest.

4. The method of claim 3 wherein the slider arrangement is associated with a scrollable application window displayed on the display screen.

5. The method of claim 4 wherein the scrollable application is arranged to display pages of a document, and the point of interest is a particular page.

6. The method of claim 4 wherein the scrollable application is arranged to display a collection, and the point of interest is a collection detent.

7. The method of claim 2 further including a second zone of slowed movement, the second zone of slowed movement being a second region associated with the bar.

8. The method of claim 1 wherein the zone of slowed movement is a friction area, and wherein the first set of information operates to impose a frictional effect with respect to movement of the position indication on the display screen.

9. The method of claim 8 wherein the frictional effect causes the first speed to be reduced.

10. The method of claim 1 further including generating the first set of information, wherein generating the first set of information includes determining an amount by which the first speed is to be reduced.

11. The method of claim 1 wherein the pointing device is a relative position pointing device.

12. The method of claim 1 wherein the pointing device is a mouse.

13. The method of claim 1 wherein the pointing device is a track ball.

14. A computer readable medium including at least tangible computer program code stored thereon for operating a pointing device with respect to display screen of a computing device, said computer readable medium comprising:
computer code for determining when a user interface control displayed on the display screen has been selected using the pointing device;
computer code for moving the user interface control at a first speed, the first speed being imparted by the pointing device;
computer code for displaying a position indication on the display screen, the position indication being arranged to represent a current position of the pointing device and a current position of the user interface control;
computer code for determining whether the current position is in a first zone of slowed movement;
computer code for providing a first set of information to the pointing device when the current position is in the first zone of slowed movement, the first set of information being arranged to reduce the first speed; and
computer code for providing a second set of information to the pointing device when the current position is not in the first zone of slowed movement, the second set of information being arranged not to reduce the first speed.

15. A computing system, comprising:
a display screen for presenting a graphical user interface, the graphical user interface having at least one slider arrangement, the slider arrangement including a slider and a bar, the bar including at least a first zone of slowed movement, wherein the slider is arranged to move relative to the bar;
a pointing device for a user to provide user input so as to manipulate a position indicator being displayed on the display screen, the pointing device further being arranged to allow the user to engage the slider and to manipulate the slider relative to the bar; and
a movement control system configured to receive the user input via the pointing device, determine whether the slider is at least partially positioned in the zone of slowed movement, and automatically slow movement of the slider when the slider is at least partially positioned in the zone of slowed movement.

16. The computing system of claim 15 wherein the movement control system is further configured to apply a friction effect to automatically slow the movement of the slider.

17. The computing system of claim 15 wherein the zone of slowed movement is defined around a point of interest associated with the bar.

18. The computing system of claim 17 wherein the amount of the friction effect being applied varies depending on the position of the position indicator within the predetermined region.

19. The computing system of claim 15, wherein the pointing device is a mouse, and wherein said computing system is a personal computer.
